(19) United States
(12) Patent Application Publication
(10) Pub. No.: US 2024/0230877 A1
(43) Pub. Date: Jul. 11, 2024

(54) A RADIO FREQUENCY TAG SYSTEM

(71) Applicant: R4DARTECH LTD, Cambridge (GB)

(72) Inventors: Clement ROBERTSON, Cambridge Cambridgeshire (GB); Stephen CLARK, Cambridge Cambridgeshire (GB)

(21) Appl. No.: 18/559,657

(22) PCT Filed: May 9, 2022
(86) PCT No.: PCT/GB2022/051176

§ 371 Date: Nov. 8, 2023

(30) Foreign Application Priority Data
May 9, 2021 (GB) 2106604.8

(51) Int. Cl. G01S 13/536; G01S 7/35; G01S 13/82

(52) U.S. Cl. CPC G01S 13/536; G01S 7/35; G01S 13/825

(57) ABSTRACT

A frequency modulated carrier wave (FMCW) radar system can identify active targets. The system includes an interrogator radar and radio frequency tag. The tag includes a transmitter adapted to transmit a binary code through transmission of a series of different discrete fixed frequencies selected from a set of more than two discrete fixed frequencies.

The interrogator radar is configured to be switchably operable between a first mode and a second mode. In the first mode the interrogator radar generates and transmits a FMCW signal in order to identify the presence of passive objects within its field of regard. In the second mode the interrogator radar transmits a relatively fixed frequency signal compared with the FMCW signal, and mixes the relatively fixed frequency signal with the series of discrete fixed frequencies received from the tag to identify the binary code.

### CROSS-REFERENCE TO RELATED APPLICATIONS

This application claims priority from and is related to the following prior application Patent Cooperation Treaty Patent PCT/GB2022/051176, filed on 9 May 2022, which claims priority to Great Britain Patent Application No. 2106604.8, filed on 9 May 2021. These prior applications, including the entirety of their written description and drawings, are collectively hereby incorporated by reference into the present application.

### BACKGROUND

Most modern radars designed for short range use, i.e., up to 1000 m, operate with a frequency modulated carrier wave (FMCW). In this approach a carrier wave is rapidly modulated by the transmitting radar. Energy reflects off objects in the field of view and a portion of this received by the radar is mixed with the transmitted carrier signal. The frequency difference between transmitted and received signals (the beat frequency/intermediate frequency) is used to measure distance to the object(s).

U.S. Pat. No. 6,100,840 relates to a tag system comprising a pulsed Doppler radar interrogator. The tag comprises an active radar reflector adapted to modify a received pulse from the pulsed Doppler radar so as to reflect a signal back to the interrogator comprising discrete frequencies that the interrogator interprets as a binary code.

To ensure the reflected return from the tag cannot be mistaken for an object having a greater relative speed to the interrogator, the tag needs to shift the received frequency to a frequency that lies outside of the band of returns expected for non-active objects. This means the interrogator needs to operate with a broader intermediate frequency band than it would need otherwise.

Notably such a system is not compatible with a FMCW radar as within a FMCW radar any intermediate frequency could be attributed to a non-active target and therefore it is not possible to dedicate a specific sub-band of intermediate frequencies for active target detection.

Further, pulsed Doppler systems are not generally suitable for detection and ranging of objects at very short ranges, i.e. 100s of meters, because of the difficulty to generate the very short pulses needed to detect objects at these ranges.

US2004/189511 describes an access control system primarily intended to be used for accessing a motor vehicle. The range between the base station 20 (in vehicle) and the code transmitter (key), and the key code are determined simultaneously by an evaluation unit 24 in the base station 20. To do this the evaluation unit 24 needs to have two demodulators: a first to extract Sig 1 from Sig 4 and a second to extract SigHT from Sig CHT.

EP1672386 describes a CW radar system that employs phase modulation for distance determination between the radar and a transponder device and amplitude modulation that allow a data transmission between the radar and the transponder. To perform these two modulation processes the radar device comprises separate mixers 136, 140.

### BRIEF SUMMARY

According to an aspect of the invention there is provided a radar and radio frequency tag system comprising an interrogator radar and a tag, wherein said tag is secured to an object; the tag comprising a transmitter through which it is adapted to transmit a binary code through transmission of a series of different discrete fixed frequencies selected from a set of discrete fixed frequencies; the interrogator radar comprising; a transmitter, a receiver, and a signal generator means adapted to generate a first signal and a second signal; wherein the first signal is a FM signal and the second signal has a relatively fixed frequency compared with the FM signal; and in which the interrogator is configured to be switchably operable between: a first mode in which the signal generator means generates the first signal, the transmitter transmits the first signal across a field of view, and the receiver is arranged to receive the reflected first signal from the object within the interrogator radar's field of view, the receiver adapted to mix the transmitted first signal with the received signal; and a second mode in which the signal generator generates the second signal and in which the second signal is mixed with the series of discrete fixed frequencies received from the tag to identify the binary code.

In the first mode the interrogator radar operates conventionally using the frequency difference between transmitted and received signals (the beat frequency/intermediate frequency) to identify the presence of, and determine range for, passive and/or active object(s) within the field of regard. From time-to-time the interrogator radar may switch temporarily to the second mode to receive binary codes from any active targets within the field of regard (e.g. to identify said active devices) before switching back to the first mode. Advantageously the radar system can operate in both modes using only a single mixer and signal generator. This permits existing FMCW radar systems to be adapted, through updating associated software, to identify active targets without the need to alter or add to the radar system hardware.

The second signal has a relatively fixed frequency compared with the FM signal in order to simplify identification of the binary code within the down converted signal. Thus, favorably the second signal has a substantially fixed frequency. Thus the interrogator can switch between modes without reconfiguring the receiver.

The interrogator radar may be a short-range radar, i.e. adapted to detect objects within a range of 2 kms of the interrogator, and preferably able to detect objects within 100 meters of the interrogator radar.

The FM signal may be a continuous wave (FMCW) signal.

The tag may be adapted to broadcast the series of discrete fixed frequencies. Alternatively, and more preferably, when in the second mode, the interrogator may be configured to transmit an activation signal and the tag configured to transmit the binary code in response to receiving the activation signal.

Transmission of the series of different discrete fixed frequencies may be made by a non-binary frequency shift keying modulation process through making discrete frequency changes to a carrier signal. The unmodulated carrier signal may have substantially the same frequency as the second signal.

Each frequency of the set of different discrete fixed frequencies may correspond to a separate bit of the binary code, the value of each bit being determined by the transmission or absence of transmission of the bit's associated frequency within the set of discrete fixed frequencies. For example, the absence of a transmitted frequency may set the bit associated with that frequency to a value=0 and the transmission of that frequency sets the bit to value=1. The order of the bits in the code may be predetermined by the position of the frequency in the set.

Consequently, the set of different discrete fixed frequencies will typically comprise a number (N) of different discrete fixed frequencies that equals or exceeds the number of bits of the binary code. Thus typically N>2.

The transmitter of the tag may be adapted to transmit each of the different discrete fixed frequencies in sequence, though in principle one or more of the frequencies could be transmitted simultaneously if the tag and interrogator were suitably configured.

The binary code may identify the tag, i.e., be unique to the tag. The binary code may identify the object on which the tag is mounted. Alternatively, the binary code may identify the type of object on which the tag is mounted, i.e., not be unique to the tag but be unique to the type of object on which the tag is mounted.

The activation signal may comprise a signal of a single substantially fixed frequency; favorably of the same frequency as the second signal. This is favorable because reflections of the activation signal from objects with the field of view received at the interrogator will produce minimal intermediate frequencies response as the returns will be of the same frequency as the second signal. Any that are produced, e.g., as a consequence of Doppler shifting, can be easily distinguished from returns attributed to the tag.

Favorably the interrogator is configured to transmit the second signal to provide the activation signal. In other words, the activation signal may comprise or consist of the second signal and is favorably substantially identical to the second signal. Thus favorably the interrogator comprises a signal generator that generates a signal and means to divide the signal into two substantially identical signals that provide the activation signal and second signal.

The activation signal may be transmitted as a continuous wave signal, i.e., transmitted substantially continuously whilst the interrogator is operating in the second mode, alternatively the activation signal may be a pulsed signal.

Alternatively, the activation signal and second signal may comprise a series of discrete fixed frequencies that correspond to a binary code. The series of discrete fixed frequencies may be transmitted by the transmitter in a sequence.

Where the activation signal and second signal comprises a series of substantially fixed frequencies, the returns from non-active objects in the field of regard will be of substantially the same frequency, aside from any Doppler shift, as the second signal with which they are mixed in the mixer and so create minimal if any intermediate frequency response.

The activation signal favorably comprises a delay between the end of transmission of each of the substantially fixed frequency of the series and the beginning of transmission of the next frequency in the series. This delay is favorably longer than the time frame that returns would be expected from non-active objects within field of regard. This ensures that any returns from objects from an earlier transmitted frequency are not received once the interrogator is generating and transmitting the next frequency, and consequently are not mixed with the second signal which will now also be at the next frequency and which would otherwise create spurious output signals. The length of the delay necessary will depend on the effective range of the interrogator. For a short range radar, e.g. detecting targets up to 2 km away, a delay of at least 15 μs would be suitable.

The series of discrete fixed frequencies of the activation signal may be encoded by frequency shift modulation of the second signal.

The signal generator means may comprise a voltage-controlled oscillator operable under control from a controller to generate both the first and second signals. Alternatively, the signal generator may comprise separate oscillators to generate the first and second signals.

In one arrangement the tag may comprise a local signal generator, including an electronic oscillator, adapted to generate the series of discrete fixed frequencies.

Alternatively, though probably less preferred in most applications because of the ready availability of off-the-shelf FMCW radar systems, the tag may comprise an active reflector means adapted to receive and modify a received signal before reflecting the modified signal back towards the interrogator.

In one application the interrogator may be carried by an automobile, e.g. as part of a driver assistance system and/or controller of an autonomous automobile.

The tag may be carried on an item of street furniture. Where so, the binary code may identify the type of street furniture, e.g., whether tag is mounted on a road sign (and optionally the type), utility pole or set of traffic lights.

In another example application, the interrogator may be carried by an unmanned aerial vehicle, e.g. operable to fly across the ground at very low altitudes, e.g., <200 m. The tag may be affixed to a ground-based structure and/or another aerial vehicle.

As such, the system may comprise a further tag, the further tag comprising a transmitter through which the further tag is adapted to transmit a different binary code through transmission of a different series of different discrete fixed frequencies selected from the set of discrete fixed frequencies.

The interrogator radar may be adapted to transmit a second activation signal which differs from the first activation signal, and in which the further tag is adapted to transmit the different binary code in response to receiving the second activation signal. As the different tags respond to different activation signals, this provides a way to differentiate between different tags lying at similar azimuth positions relative to the interrogator radar.

The second activation signal may be transmitted in a different frequency band to the first activation signal alternatively or additionally, where the first and second activation signals comprise a series of substantially fixed frequencies, the second activation signal may comprise a different selection of frequencies to the first activation signal.

### BRIEF DESCRIPTION OF THE DRAWINGS

The accompanying figures in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a schematic of a radar and radio frequency tag system illustrating an interrogator and a tag transponder;

FIG. 2 is an illustration of a simulated power spectra for a five-bit wide code;

FIG. 3 is a schematic illustrating the frequencies transmitted by the interrogator and tag in an exchange whilst the interrogator is operating in the active target detection mode;

FIG. 4 is a simulated spectra of beat frequencies expected at the output of the tag's mixer upon receipt of an activation code of value 11101; and

FIG. 5 is a simulated spectra of beat frequencies expected at the output of the interrogator's mixer upon receipt of an ID code of value 11001.

### DETAILED DESCRIPTION

As required, detailed embodiments are disclosed herein; however, it is to be understood that the disclosed embodiments are merely examples and that the devices and methods described herein can be embodied in various forms. Therefore, specific structural and functional details disclosed herein are not to be interpreted as limiting, but merely as a basis for the claims and as a representative basis for teaching one of ordinary skill in the art to variously employ the disclosed subject matter in virtually any appropriately detailed structure and function. Further, the terms and phrases used herein are not intended to be limiting, but rather, to provide an understandable description. Additionally, unless otherwise specifically expressed or clearly understood from the context of use, a term as used herein describes the singular and/or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising i.e., open language. The term “coupled,” as used herein, is defined as “connected,” although not necessarily directly, and not necessarily mechanically.

It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

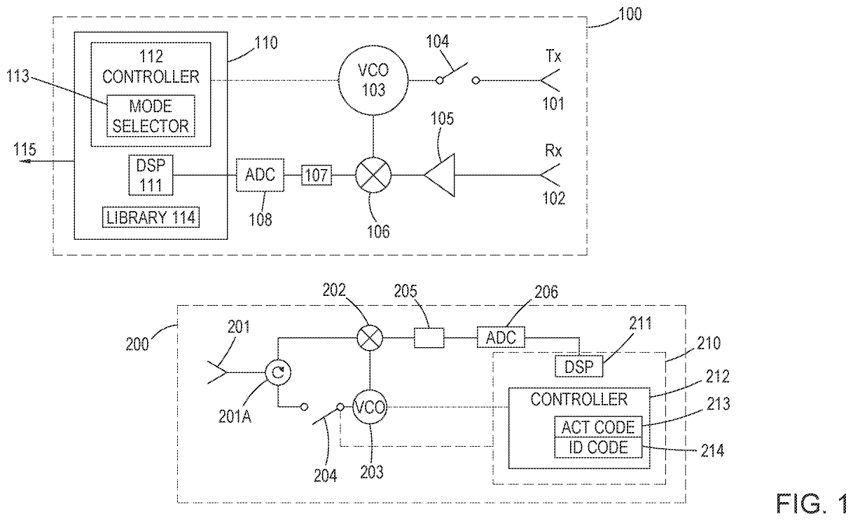

FIG. 1 is a simplified schematic illustration of a radar and radio frequency tag system comprising an interrogator radar 100 and a tag transponder (tag) 200 which is mounted onto an object (not shown) within the interrogator radar's 100 field of regard.

The interrogator radar 100 comprises a transmitting antenna 101, a separate receiving antenna 102, a voltage-controlled oscillator (VCO) 103, switch 104, a low noise amplifier 105, a radio frequency mixer 106, filter 107, an analogue to digital converter 108, and a processor system 110 that implements functions including a digital signal processor (DSP) 111 a controller 112 including a mode selector sub-function 113.

The interrogator radar 100 has separate transmitting and receiving apertures configured to allow both the transmitter and receiver to operate simultaneously.

The processor system 110 also includes a computer readable memory that holds a code library 114 which includes a list of tag ID codes and for each ID code corresponding information that identifies the tag 200 and/or object on which the tag 200 is mounted.

Under control of the mode selection function 113 of the interrogator controller 112, the interrogator radar 100 is switchably operable between a FMCW radar mode and an active target detection mode.

In the FMCW radar mode the switch 104 is closed and the VCO 103 caused to generate a rapidly modulated carrier signal such that a FMCW signal is transmitted through the transmitting antenna 101 across a field of regard.

Parameters such as the operating frequency, modulation pattern (e.g. sawtooth, triangular or sinusoidal), and the swept bandwidth slope will depend on application requirements. It is envisaged that most applications will be for short range use, i.e. ranging objects within two kilometres which will often include ranging of objects less than 100 m from the interrogator 100. For automobile applications an operating frequency between 76 GHz to 81 GHz is suitable. To provide the necessary resolution at the aforementioned range a swept bandwidth slope above 10 Khz per 1 μs is suitable though above 1 MHz per 1 μs more favorable. Nevertheless, these values should not be taken as limiting.

Reflected returns of the FMCW signal received at the receiver antenna 102 from objects in the field of regard are amplified by the low noise amplifier 105 and inputted to the mixer 106. The output of the VCO 103 is also connected to an input of the mixer 106 such that the output of the VCO 103 simultaneously provides a local oscillator (lo) signal to be mixed with the signals received at the receiver antenna 102 which is substantially identical to that signal being transmitted. When mixed, the reflected returns have a different frequency to the lo signal giving rise to the presence of intermediate frequencies in the output of the mixer 103 indicative of the range of the object from the interrogator. The amplitude (power) of the intermediate frequencies is indicative of the object's radar cross-section.

Output from the mixer 106 is filtered by filter 107 to isolate the desired intermediate frequencies, digitized by the ADC 108 and passed to the DSP 111. Details of potential targets are outputted via output 115, e.g., to the system to which the interrogator is connected. For example, an advanced driver-assistance system of the vehicle (or control system where an autonomous vehicle).

The transmitting antenna 101 may be implemented by a phased array antenna, favorably electronically scanned phased array antenna, allowing the FMCW signal to be focused about a narrow beam that can be swept over a wide field of regard to accurately position identified objects about the azimuth and/or elevation.

This operation is conventional to FMCW radar and so will not be detailed further.

From time-to-time under control of the mode selector sub-function 113, the interrogator 100 is temporarily switched to the active target detection mode to determine the presence of and identify any active targets within the field of regard.

The mode selector sub-function 113 may be configured to switch operation to the active target detection mode periodically, e.g., after a certain period of time has elapsed, certain number of FMCW frequency sweeps have been completed or, where applicable, after a certain number of sweeps of the FMCW beam across the field of regard.

Alternatively, or additionally, the mode selector sub-function 113 may switch the interrogator to the active target detection mode in response to identifying the presence of a new object within the field of regard.

In active target detection mode the VCO 103, under control of the controller 113, generates a sequence of substantially fixed frequency RF signals selected from a set of frequencies. The selected frequencies represent a binary activation code held in the code library 114. The sequence is transmitted by the transmitter 101 and used as the lo signal inputted to the mixer 103.

A delay is provided between cessation of transmission of each frequency of the sequence and the start of transmission of the next in the sequence that is longer than the time taken to receive any returns from objects in the field of regard. This prevents intermediate frequencies being generated as a result of returns from the earlier transmitted frequency being mixed with the lo of the subsequent generated frequency. For short range applications any returns would be expected within a few microseconds, where so, a suitable duration for the delay would be ≥10s of microseconds. In practice the time taken to by the controller 112 to cause the VCO 103 to generate the next frequency of the sequence is longer than the time taken to receive expected returns so intentional provisioning of this delay within the transmission sequence is not expected to be needed. This contrasts with operation in FMCW mode in which a single programming operation will typically be used to generate the frequency chirp.

The activation code is transmitted through frequency shift key modulating a carrier of frequency (fc) within the FMCW band. A frequency band associated with the carrier frequency is divided into sub-bands each sub-band being assigned to a specific bit position within the binary code. The presence or absence of a frequency within a sub-band denotes the bit value for the bit position.

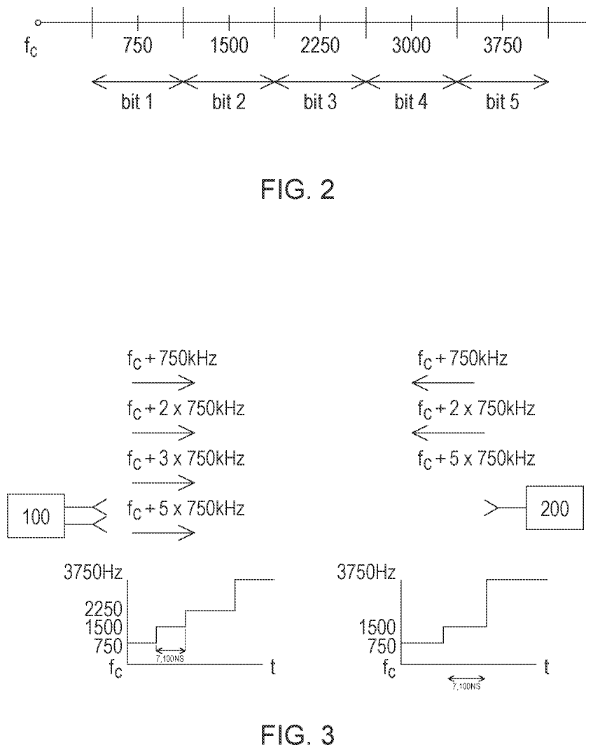

FIG. 2 is a schematic illustrating an example assignment of sub-bands to bit positions in a five-bit binary code.

The frequency band is divided into sub-bands, the first band centered at fc+750 kHz, and the others at multiples of 750 kHz, i.e., fc+2*750 kHz, fc+3*750 kHz, fc+4*750 kHz, fc+5*750 kHz. It will be appreciated that this can be extended to fc+N*750 kHz where a N bit binary number is used. Frequencies stepped by the same interval below fc could also be used, e.g., fc−750 KHz.

With reference FIG. 3, to transmit a five binary bit code of value 11101 a signal is transmitted at each of frequencies fc+750 kHz, fc+2*750 kHz, fc+3*750 kHz, and fc+5*750 kHz but not at fc+4*750 kHz. In this example protocol, the presence of a frequency corresponds to a bit value=1 and the absence of frequency corresponds to a bit value=0.

The interrogator 100 transmits the code at least twice to improve the likelihood of receipt in full by any tag 200 present. Because each frequency of the set of frequencies is assigned to a specific bit position, the order that the frequencies are received by the tag 200 is unimportant. As such it is also apparent that the order that the frequencies are transmitted is also unimportant. Once the code has been transmitted, the interrogator 100 stops transmitting (the controller 112 opens switch 104) in order to wait for a response. The VCO 103 continues to generate the carrier frequency, fc, which continues to be inputted to the mixer 104 to be mixed with any signals received from receiver antenna 102.

The spacing value of 750 kHz is not important. Nevertheless, the spacing value between each frequency of the set of frequencies should be large enough (or in other words that each sub-band is wide enough) to prevent Doppler shifting, as a result of the relative speed difference between the interrogator 100 and tag 200, causing ambiguity in identifying which frequency of the set has been transmitted.

Referring back to FIG. 1, the tag transponder 200 comprises a shared transmitting and receiving antenna 201 and circulator 201A, a mixer 202, VCO 203 having outputs connected to both the mixer 202 and to the antenna 201 through a switch 204, a filter 205, ADC 206 and transponder processor 210 that implements functions that include a digital signal processor (DSP) 211 and a controller 212. The controller 212 includes a computer readable memory that holds the binary activation code 213, and a binary ID code 214 which identifies the tag 200.

In its default operating mode, the tag 200 operates in a passive listening mode in which the mixer 202 mixes signals received at antenna 201 with a lo signal of frequency fc (i.e. the same as the carrier frequency) generated by the VCO 203. The output of the mixer 202 is filtered using filter 204, digitized by the ADC 205 and processed by the tag's DSP 211 to listen for the activation code.

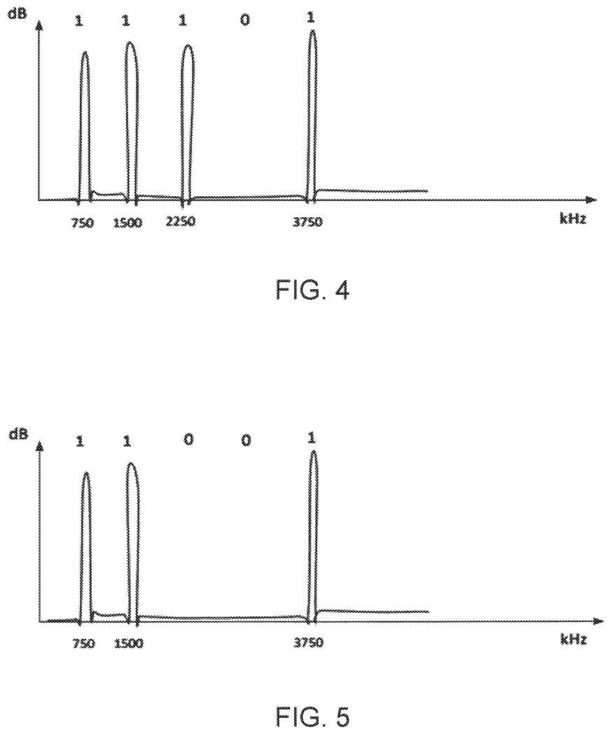

The spectra of intermediate frequencies expected upon receipt of a five-bit binary code of value 11101 following mixing with fc in the mixer 202 is illustrated in FIG. 4.

Once the controller 212 has determined receipt of the activation code, the controller 212 temporary activates the tag 200 to transmit its ID code 214 in reply.

The ID code is transmitted using the same process of frequency shift key modulating the carrier wave fc as used by the interrogator 100 to transmit the activation code, namely through transmitting a sequence of different fixed frequencies selected from the set of frequencies.

Referring back to FIG. 3, for example, if the ID code is a five-bit binary code of value 11001, the VCO 203 is caused, under control of controller 212 to generate frequencies fc+750 kHz, fc+2*750 kHz and fc+5*750 kHz but not at fc+3*750 kHz or fc+4*750 KHz.

The series of frequencies that correspond to the ID code are generated by the VCO 203 under control of the controller 212 and transmitted via the antenna 201, which has been put into connection with the VCO 203 by the controller 212 by closing switch 204.

The transmitted signals are received at the interrogator receiver 102, amplified by amplifier 105 and inputted to the mixer 104 where they are mixed with the local oscillator signal of frequency fc from the VCO 103.

The spectra of intermediate frequencies (beat frequencies) expected at the output of the mixer 106 upon receipt of a five-bit binary code of value 11001 is illustrated in FIG. 5.

Received codes are looked up in code library 214 to determine the identity of the tag and/or object on which the tag is mounted and the identifying information outputted via output 115 to the connected system.

As in the FMCW radar mode, the transmitter 101 may be configured to sweep a narrow beam across the field of regard. At each boresight position the activation code is transmitted followed by a listening period for returns from any tags 200 present to be received before moving to the next boresight position and repeating. In this way accurate position information of the tag 200 in the azimuth and/or elevation within the field of regard can be obtained. The range to a detected tag 200 is then determined by measuring the range in FMCW radar mode, at the azimuth where the tag 200 is detected.

In applications where the tag is not tied to an object of interest, e.g. is being used as a navigation beacon on the ground, or is mounted to an object having a relatively small radar cross-section, the tag 200 may include or be mounted to a radar reflector (trihedral, or other) to provide to the interrogator 100, an enlarged apparent radar cross-section.

The use of the FMCW radar mode and active target detection mode together allow detection of tags against clutter as well as 2D or 3D positioning

The ID code may be programmed into a non-volatile memory of the tag 200 providing a permanent identifier of the tag. Alternatively, the tag 200 could be re-programmable in order that the code can be changed.

The above technique can also be used to cause the tag 200 to transmit additional information to the interrogator. For example, in the application where the tag is mounted on street furniture, the tag could be re-programmed as needed to provide a warning of dynamic events occurring in its proximity, for example, provide warning of a road traffic accident or environmental factors leading to temporality poor road conditions such as the presence of ice on road.

In a simpler variant to the afore described system, the tag 200 may be activated to transmit its ID code 214 in response to receiving a specific single fixed frequency signal, e.g. the unmodulated carrier frequency signal. As before the VCO 103 of the interrogator 100 would provide that same signal to the mixer 104.

In a yet further simplification, the tag 200 may instead be configured to broadcast its ID code periodically. Where so the interrogator 100 need not transmit an activation signal when in the active target detection mode. The carrier frequency on which the ID code is transmitted made be selected to lie outside the band of the FMCW chirp transmitted in the FMCW radar mode to avoid transmissions from the tag 200 creating spurious signals at the interrogator during operating in FMCW radar mode. This variant is, however, less preferred for a number of reasons including that it does not allow for accurate positioning of the tag within the azimuth or elevation of the field of regard; it requires increased power consumption and uses the available bandwidth inefficiently.

It is preferred that the same carrier frequency is used by the interrogator and tag for transmitting the activation signal and the ID code respectively, though this is not essential.

In applications where multiple tags may be expected to appear on the same azimuth and so could both be activated simultaneously, different tags may be configured to be activate by different codes or the same code transmitted on different frequency bands. Where so the interrogator could be configured transmit the different activation codes (or repeat the code on different bands) sequentially at each azimuth position to activate the tags sequentially.

Rather than a shared antenna and circulator, the tag could, like the interrogator, comprise separate transmitting and receiving antenna instead.

The Abstract is provided with the understanding that it is not intended be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

Although specific embodiments of the subject matter have been disclosed, those having ordinary skill in the art will understand that changes can be made to the specific embodiments without departing from the scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A radar and radio frequency tag system comprising:
an interrogator radar and a tag, wherein said tag is secured to an object;
the tag comprising a transmitter through which it is adapted to transmit a binary code through transmission of a series of different discrete fixed frequencies selected from a set of discrete fixed frequencies;
the interrogator radar comprising; a transmitter, a receiver, a mixer, and a signal generator adapted to generate a first signal and a second signal; wherein the first signal is a FM signal and the second signal has a relatively fixed frequency compared with the FM signal; and in which
the interrogator radar is configured to be switchably operable between:
a first mode in which the signal generator means generates the first signal, the transmitter transmits the first signal across a field of view, and the receiver is arranged to receive a reflected first signal from the object within the interrogator radar's field of view; the receiver adapted to mix, in the mixer, the transmitted first signal with the received signal; and
a second mode in which the signal generator generates the second signal, and in which the second signal is mixed in the mixer with the series of different discrete fixed frequencies received from the tag to identify the binary code.

2. A radar and radio frequency tag system according to claim 1 wherein in the second mode the interrogator radar is adapted to transmit an activation signal, and the tag is adapted to transmit the series of different discrete fixed frequencies in response to receiving the activation signal.

3. A radar and radio frequency tag system according to claim 1 wherein the tag comprises a local signal generator adapted to generate the series of different discrete fixed frequencies.

4. A radar and radio frequency tag system according to claim 3 wherein the tag is adapted to transmit the series of different discrete fixed frequencies at least twice in response to receiving the activation signal.

5. A radar and radio frequency tag system according to claim 2 wherein the activation signal comprises a series of different discrete fixed frequencies and the tag is adapted to identify a binary code defined by the series of different discrete fixed frequencies.

6. A radar and radio frequency tag system according to claim 1 comprising: a further tag, the further tag comprising a transmitter through which it is adapted to transmit a different binary code through transmission of a series of different discrete fixed frequencies selected from a set of discrete fixed frequencies.

7. A radar and radio frequency tag system according to claim 6 wherein the interrogator radar is adapted to transmit a second activation signal and in which the tag is adapted to transmit the binary code in response to receiving the activation signal and the further tag is adapted to transmit the further binary code in response to receiving the second activation signal.

8. A radar and radio frequency tag system according to claim 1 wherein the interrogator radar comprising:
a transmitter, a receiver, and a signal generator adapted to generate a first signal and a second signal; wherein the first signal is an FM signal and the second signal has a relatively fixed frequency compared with the FM signal; and in which
the interrogator radar is configured to be switchably operable between:
a first mode in which the signal generator generates the first signal, the transmitter transmits the first signal across a field of view, and the receiver is arranged to receive a reflected first signal from an object within the interrogator radar's field of view; the receiver adapted to mix the transmitted first signal with the received signal; and
a second mode in which the signal generator generates the second signal, and in which the second signal is mixed with the series of different discrete fixed frequencies received from the tag to identify the binary code.
